(19) United States
(12) Patent Application Publication
(10) Pub. No.: US 2005/0210108 A1
(43) Pub. Date: Sep. 22, 2005

(54) System and method for creating customized electronic messages

(76) Inventors: John Covert, Kennett Square, PA (US); Joseph Mezera, Hilton Head Island, SC (US)

Correspondence Address: MCNAIR LAW FIRM, PA, P.O. BOX 10827, GREENVILLE, SC, 29603-0827, US

(21) Appl. No.: 10/804,388

(22) Filed: Mar. 19, 2004

(51) Int. Cl. G06F 15/16

(52) U.S. Cl. 709/206; 709/246

(57) ABSTRACT

A system and method for creating customized electronic messages to allow for enhanced and customized appearance and presentation of electronic messages. This system and method takes an original electronic message, retrieves a wrapper from a set of wrappers located on a wrapper server, creates a branded electronic message prior to transmission to a recipient and allows the sender to preview the branded electronic message prior to its transmission.

### FIELD OF THE INVENTION

This invention is directed to a system and method for creating customized electronic messages, specifically for enhancing the appearance and presentation of electronic messages.

### BACKGROUND OF THE INVENTION

Electronic messages, including email, are fast becoming the most widely used form of communication in industry today. Electronic communication is attractive to users because it is both fast and unobtrusive. Electronic communication has all the benefits of sending a letter, without any of the delays of sending it through the Post Office. Further, electronic communication is unobtrusive in that it allows a user to receive a message and determine how and when a response, if any, will occur. This form of communication is far superior than phone calls in that the recipient does not feel obligated to answer the electronic communication immediately.

As companies are using electronic communications more and more, a significant advantage is realized when a company can customize or “brand” its electronic communications, such as emails, with information about the company. Just as letterhead provides information such as mailing addresses, phone numbers, fax numbers, email addresses, etc. to the recipient, so would branded electronic messages. Further, branding electronic messages allows them to have a distinctive look which can increase the chance that the message will be reviewed or will receive increased attention by the recipient. This is especially true if the message is distinctive in appearance from the other messages received by the recipient.

Previously, attempts have been made to brand emails. However, these attempts have only moderate success. The majority of these attempts employ a centralized email server or additional interception application to intercept emails from the sender's email client as emails are being sent. These attempts apply the company name or other information to the email while the email is in transit rather than before the email is even sent. There are several disadvantages to these attempts. First, the sender is deprived of the opportunity to review the email prior to when the email is sent. For example, U.S. patent application Publication 2001/0032240 A1 to Malone et al. uses a message engine to receive the message text from the sender, build the “enhanced” message, and send the message to a user. Since this reference is limited to using a separate application for intercepting messages, the user is deprived of the ability to review the final message to the recipient. U.S. patent application Publication 2002/0019849 A1 to Turvey, et al. suffers the same disadvantages. An electronic communications processing engine sends information about an existing electronic communication to a remote server that replies causing the electronic message to be modified and transmitted to the recipient. Specifically, the electronic message is intercepted en route to the recipient so that the sender is deprived the ability to review the final message. Further, U.S. patent application Publication 2002/0019849 A1 is expressly limited to directing an email along an enhancement path after the email message has been originated by the sender.

Second, the systems in the attempts described above intercept the message and reroute the message to additional applications prior to the message being sent. These additional steps and applications can increase the risk of interception or other mischief from a third party or hacker to the sender and recipient. These attempts also fail to allow the user to correct or otherwise modify the branded email once the modifications to the email are performed by additional applications after the email is sent by the sender.

Therefore, it would be advantageous to have a system that allows for user based customized branding of electronic messages. It would also be advantageous to have a system and method for allowing the branded email to be created and reviewed by the sender prior to transmission. It would also be advantageous to have a system and method for allowing branded messages to be viewed by any recipient using any type of email client without the need for downloading or otherwise installing additional programs. It would be further advantageous to have a system and method for allowing for the creation and transmission of branded email regardless of the particular email server used.

Therefore, it is an object of this invention to provide a system and method for branding email and allowing the sender to review the branded email prior to its transmission.

Another object of this invention is to provide a system and method that allows for branding of emails according to specific user information and preferences.

Another object of the present invention is to provide a system and method for creating branded emails that can be viewed regardless of the email owner or recipients' email client used.

### SUMMARY OF THE INVENTION

The above objectives are accomplished according to the present invention by providing a system for integrating with an existing electronic message client for creating customized electronic messages made up of a computer readable medium, at least one message wrapper in communication with the computer readable medium, and a set of computer readable instructions stored in the computer readable medium. The instructions include instructions for receiving an electronic message from the user, retrieving a message wrapper and integrating the wrapper with the electronic message to create a branded electronic message prior to transmitting the electronic message to the recipient. Thus, a branded electronic message is created for transmission to the recipient. The system can also include a set of message wrappers in communication with the computer readable medium having a plurality of message wrappers; and, user information in communication with the computer readable medium having wrapper preference information representing the preferred wrapper of the user from the set of message wrappers. The set of instructions can include instructions for retrieving at least one wrapper from the set of message wrappers according to the user information. The computer readable instructions can include instructions for receiving wrapper selection information from the user and retrieving a second message wrapper from the set of message wrappers according to the wrapper selection information so that the second message wrapper can be used to create the branded electronic message. The set of computer readable instructions can include instructions for displaying the branded electronic message to the user so that the user can preview the electronic message integrated with the wrapper prior to sending the branded electronic message to the recipient. The system can also include: user information in communication with the computer readable medium having preview preference information representing whether the user wishes to preview the branded electronic message prior to its transmission; and the set of computer readable instructions can include instructions for displaying the branded electronic message automatically according to the user information so that the user can preview the electronic message integrated with the wrapper prior to its transmission. The computer readable instructions can include instructions for canceling transmission of the branded electronic message prior to transmission to the recipient. The set of computer readable instructions can include instructions for retrieving at least one wrapper from the set of wrappers, receiving modification instructions representing changes to the wrapper, modifying the wrapper according to the modification instructions, and storing the modified wrapper back in said set of wrappers.

The objects are further accomplished by a system for integrating with an electronic message client for creating customized electronic messages made up of a computer readable medium; and, a set of computer readable instructions embodied in the computer readable medium for functioning in conjunction with the electronic messaging client and receiving an electronic message generated from the electronic messaging client prior to transmission to a recipient, retrieving a message wrapper from a set of message wrappers in communication with the computer readable medium, integrating the electronic message with the wrapper for creating a branded electronic message so that a branded electronic message is created for transmission to recipient. The set of computer readable instructions can include instructions for retrieving user information representing user preferences from the electronic messaging client and retrieving a wrapper according to the user information so that the branded electronic message is created according to user preferences. The computer readable instructions can include instructions for displaying the branded electronic message so that a user can preview the electronic message integrated with a wrapper prior to transmitting the branded electronic message to the recipient. The computer readable instructions can include instructions for canceling transmission of the branded electronic message prior to its transmission to the recipient. The computer readable instructions can include instructions for retrieving at least one wrapper from the set of message wrappers according to user information representing a preferred wrapper of the user. The computer readable instructions can include instructions for receiving wrapper selection information and retrieving a second message wrapper from the set of wrappers according to the wrapper selection information so that the branded electronic message can be created with the second message wrapper.

The objects of the invention are further accomplished by a method for creating customized electronic messages using an existing electronic message client. The method comprises the steps of: receiving an electronic message from a user providing at least one message wrapper; and creating a branded electronic message by integrating the electronic message with the message wrapper prior to initiating transmission of the electronic message to a recipient. The method can include the step of providing at least one message wrapper according to wrapper selection information representing the message wrapper preference of the user. The method can include the step of canceling transmission of the branded electronic message prior to its transmission to the recipient. The method can include the step of displaying the branded electronic message to the user so that the user can preview the branded electronic transmission prior to its transmission. The method can include the step of modifying the branded electronic message prior to its transmission to the recipient. The method can include the step of transmitting branded electronic message to the recipient.

### DESCRIPTION OF THE DRAWINGS

FIG. 1 is a block diagram showing generally elements associated with this invention.

FIG. 2 is a flowchart detailing the functionality of this invention.

FIG. 3 is a flowchart detailing the functionality of this invention.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The terms “host” and “server” may be hardware, software, or combination of hardware and software that provides the functionality described herein. This invention thereby allows multiple users, being geographically dispersed, to interact with data relating to physical characteristics of manufactured products using a system that ensures the precise and accurate conveyance of such information.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus providing steps for implementing the functions specified in the flowchart block or blocks. Accordingly, elements of the flowchart support combinations of means for performing the special functions, combination of steps for performing the specified functions and program instruction means for performing the specified functions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

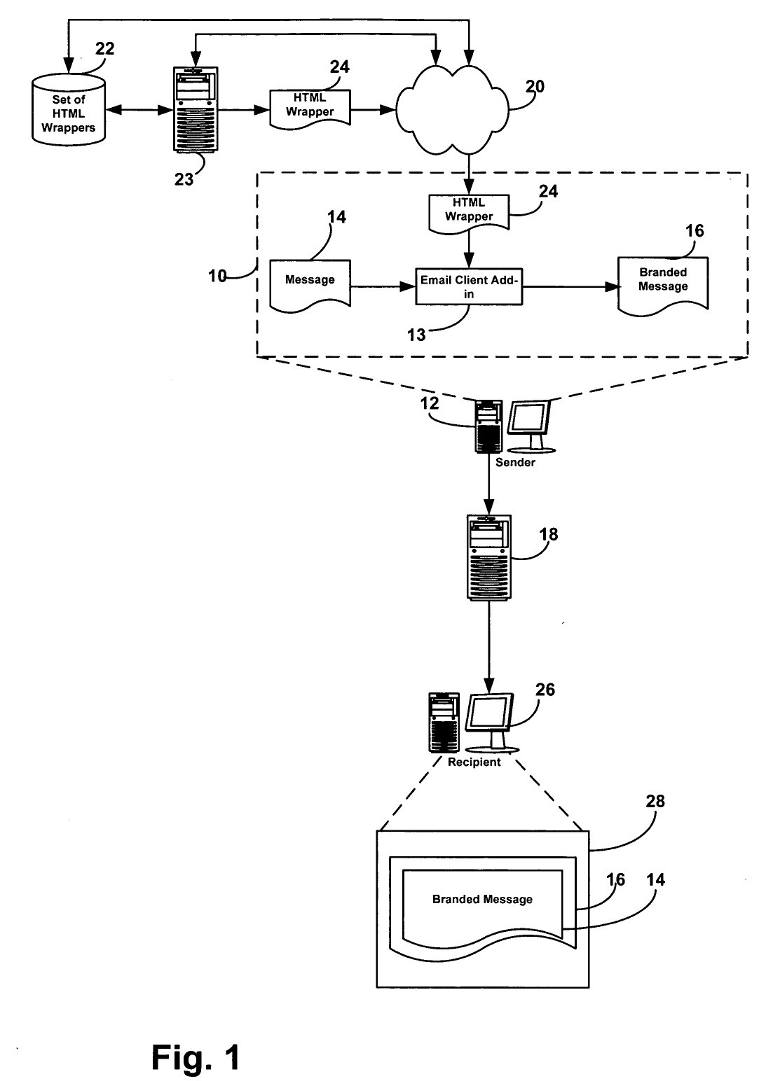

Referring now to FIG. 1, a schematic of the invention is shown. The user or sender using sender computer 12 creates an electronic message, such as a text message, email, page or other electronic message (hereinafter “email”), to be sent to a recipient who is using recipient computer 26 via email server 18. The sender creates the electronic message using an email client 10. In a preferred embodiment, the email client is one such as Eudora, Microsoft Outlook, Microsoft Outlook Express, or Lotus GroupWise client. The user creates in the electronic message to be sent by entering text resulting in electronic message 14. The user then requests for message 14 to be sent to a recipient, usually by clicking on or initiating the send command. Traditionally, message 14 would then be sent to email server 18 and transmitted to recipient 26 so that the recipient can view the message. However, according to the present invention, a set of computer readable instructions 13 do not allow message 14 to be sent to the recipient at this point. Instead, the computer readable instructions check to see if there are user preferences associated with the sender that include wrapper selection information. According to this invention, there are several user preferences that can be selected by the user or sender. The user can select to have electronic messages branded or not branded. The user can select a preferred wrapper to be used for branding electronic messages. The user can select to preview branded messages prior to the branded message being sent. Since this invention brands the electronic message prior to transmission of the electronic message to the recipient, or even the email server, the user can decide to send the branded electronic message, modify it or even cancel or delete it. If wrapper selection information exists, the computer readable instructions retrieve at least one wrapper, according to the wrapper selection information, with which to wrap the electronic message. If there are no user preferences associated with the sender that include wrapper selection information, a default wrapper is selected. In one embodiment, the sender is provided with the selected wrapper, according to wrapper selection information or default information, but allowed to manually select another wrapper to be used to brand the email.

In the preferred embodiment, the message wrapper is in an HTML format. A set of message wrappers 22 that are in communication with the computer readable instructions 13 via network 20 can be located within the computer readable medium having computer readable instructions 13 to allow “local” access to the set of message wrappers or can be located in a computer readable medium of wrapper server 23 that is apart from the computer readable instructions for “remote” access to the set of message wrappers. In either case, the set of message wrappers can be centrally modified by someone other than the user, such as but not limited to, a systems administrator so that multiple senders can access the same set of wrappers and take advantage of the modifications made to the set of message wrappers. This functionality insures that each sender has the most current wrapper with the most current content for each wrapper. While the entire set of wrappers can be made accessible to every sender or every email client, the access to the set of wrappers can also be limited based upon user preferences or information or email client preferences or information. For example, some email clients or some users or sender may be restricted from viewing, selecting, or using some wrappers within the set of wrappers. Message wrapper 24 can contain information such as logos, links or other information the sender wishes to use to encapsulate the electronic message created by the sender. Note that the message wrapper can be stored in local cache memory so as to avoid having to retrieve the same message wrapper from the set of wrappers multiple times when it is used for multiple electronic messages.

Once the computer readable instructions 13 retrieve a message wrapper 24, the computer instructions create a branded message 16. Branded message 16 contains the original message text 14 as created by the sender, wrapped with the selected message wrapper 24.

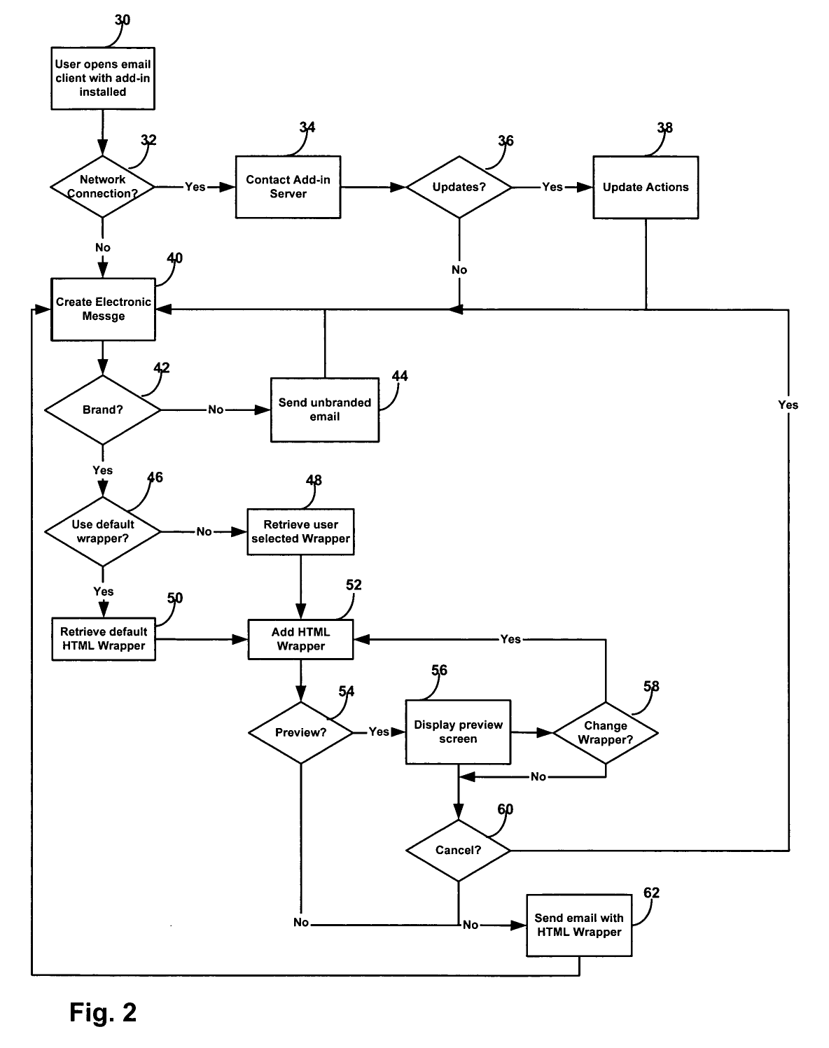

Once the branded message 16 has been created and either set for automatic transmission to the recipient, modified and set for transmission to the recipient, or simply set for transmission by the sender after the sender is given an opportunity to review the message, the branded electronic message is transmitted to email server 18 and on to recipient computer 26 so that the recipient may view the message in the recipient's email client 28. Since the branded electronic message containing the original text wrapped in the HTML wrapper, the branded message is transmitted as one file retrieved and reviewed by the recipient. Referring to FIG. 2, the process of a branded electronic message is described in more detail.

At step 30, the user or sender starts the email client having the computer readable instructions of this invention. As described herein, the computer readable instructions of this invention are an “add-on” to the email client and provide the functionality described herein. When the email client is started, the existence of a functioning network connection is made at step 32. If the network connection is functioning, the invention can contact wrapper server 23 to determine if any actions need to be taken according to updates to the set of message wrappers, updates to computer readable instructions to be made, updates to user or sender preferences, or other such update information at step 34. If such action needs to be taken as determined at step 36, the corresponding action is taken at step 38. For example, if there are updates to the set of wrappers, the updates are sent to the computer readable instructions of the invention. If wrappers are added or removed from the set of wrappers, the invention will have the list of available wrappers modified for the user or sender. If wrapper content has changed, the invention can be informed to retrieve the new wrapper rather than using one locally such as from cache. It should be noted that when a wrapper's content is changed, the wrapper server can inform each invention in communication with the wrapper server not to use any local or cached version of that wrapper, but to retrieve a current version from the wrapper server. Further, if there are modifications or updates to the computer readable instructions of the invention, these can be downloaded and the computer readable instructions updated accordingly. Updates to user preferences can be acted upon and the user's preferred wrapper can be changed, the wrappers accessible by the user can be changed or other user preference changes be made.

Regardless of whether a network connection was found at step 32, the next step is for the sender to create an electronic message at step 40 and indicates that the electronic message is complete. Indicating that the message is complete can be done by initiating the traditional “send” command of the email client since the computer readable instructions of this invention do not allow for the transmission of the electronic message at this point.

Once the electronic message is completed at step 40, a determination is made as to whether the sender wishes to brand the electronic message at step 42. If the sender's preferences are to have no branding or the sender cancels branding, the unbranded message is sent to the recipient at step 44. Otherwise, a determination is made at step 46 to see if the sender's preferences include wrapper preference information. If so, a corresponding wrapper to the user's preferences is retrieved from the set of wrappers, or from cache, at step 48. Otherwise, a default wrapper is retrieved at step 50, and is used with the electronic message to create a branded electronic message at step 52. Next, a determination is made as to whether the sender wished to preview the branded email at step 54. The ability to preview the branded electronic message can be determined from automatic preview according to the user preferences from the user manually wishing to preview the branded electronic message. If the branded electronic message is to be viewed, the branded message is displayed at step 56. At step 58, the sender has the option to select another wrapper and if another wrapper is selected, the invention returns to step 54. If the sender does not select another wrapper, or preview was not determined at step 54, the sender can still cancel sending the branded electronic message at step 60. If not cancelled, the branded electronic message is sent at step 62 to the recipient. It should be noted that this invention can also be configured to simply send the branded electronic message after step 52.

Further, prior to informing the invention that the electronic message is complete at step 40, the user can manually select a HTML wrapper from a dropdown list of available message wrappers after step 42. This selection process can occur anytime during the message authoring process. If the sender does manually select a wrapper, the invention can be configured to skip from step 40 to step 52. Further, if the invention does not have the preview functionality set for automatic preview and if the cancel option is not enabled, the branded electronic message would be transmitted with the manually selected wrapper at step 62.

When retrieving the message wrapper, the invention can either retrieve the wrapper from the user's local cache, or directly from the wrapper server. When the wrapper is cached, the computer readable instructions do not need to retrieve the message wrapper from the wrapper server each time a message is branded. Generally message wrappers that are listed in the user's dropdown list of available message wrappers have already been stored in the user's local message wrapper cache.

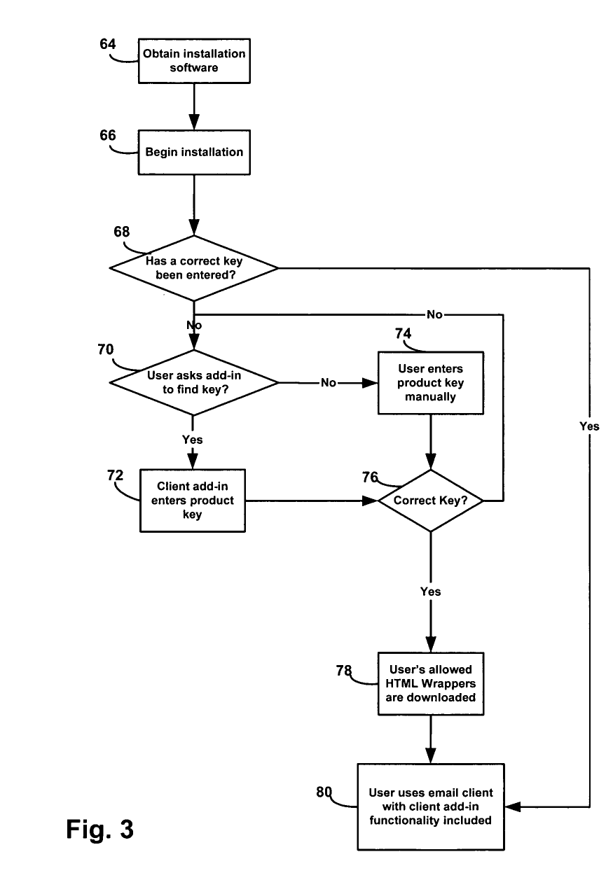

Referring now to FIG. 3, the installation and activation of the invention is described in more detail. At step 64, the user obtains the software necessary to install the invention and add it to the user's existing email client. As known to those skilled in the art, the software can be obtained on computer readable medium such as CD's, DVD's or floppy disks, as well as downloaded from remote locations such as the wrapper server. Once the necessary software has been obtained, the invention must be authorized for use with a product license key. The product license key can be sent to the user via a standard email message, or other communications means, and is generated after the vendor of the invention identifies the user of the software. Once installation begins at step 66, the invention requests the input of a valid product license key at step 68. If no valid key is entered at step 68, the invention can query the user whether to automatically find the license key in the user's email inbox at step 70. If the user selects “Yes”, the invention will attempt to locate the license key message in the inbox. If the license key message is found, the invention will load the license key for the user automatically at step 72. If the user selects “No”, the user can simply enter the license key manually, at step 74.

After the license key has been located or manually located, the license key is validated at step 76. Validation is performed by verifying the found or entered license key with an administration database of valid license keys and returning valid or invalid information. If the license key is not valid, the installation of the invention is not completed and the invention is not used by the user for creating branded email.

However, a successful validation of the license key allows for the completion of installation. The user preferences are used to download the message wrappers from the wrapper server that the user has been granted permission to use by the account administrator at step 78. After the message wrapper has been downloaded, the message wrappers can then be placed in cache according to use of the invention. The user can now take advantage of the functionality described herein.

While a preferred embodiment of the invention has been described using specific terms, such description is for illustrative purposes only, and it is to be understood that changes and variations may be made without departing from the spirit or scope of the following claims.

1. A system for integrating with an existing electronic message client for creating customized electronic messages comprising:
a computer readable medium;
at least one message wrapper in communication with said computer readable medium; and
a set of computer readable instructions embodied in said computer readable medium for receiving an electronic message from the user, retrieving said at least one message wrapper and integrating said at least one wrapper with said electronic message for creating a branded electronic message prior to instigating transmission of said electronic message to the recipient so that a branded electronic message is created for transmission to the recipient.

2. The system of claim 1 including:
a set of message wrappers in communication with said computer readable medium having a plurality of message wrappers;
user information in communication with said computer readable medium having wrapper preference information representing the preferred wrapper of the user from said set of message wrappers; and,
said set of computer readable instructions include instructions for retrieving at least one wrapper from said set of message wrappers according to said user information.

3. The system of claim 2 wherein said computer readable instructions include instructions for receiving wrapper selection information from the user and retrieving a second message wrapper from said set of message wrappers according to said wrapper selection information so that said second message wrapper can be used to create said branded electronic message.

4. The system of claim 2 wherein said computer readable instructions include instructions for updating said set of wrappers and said user information whereby said set of wrappers and said user information can be centrally modified.

5. The system of claim 1 wherein said set of computer readable instructions include instructions for displaying said branded electronic message to the user so that the user can preview the electronic message integrated with said at least one wrapper prior to transmission of said branded electronic message to the recipient.

6. The system of claim 1 including:
user information in communication with said computer readable medium having preview preference information representing whether the user wishes to preview said branded electronic message prior to its transmission; and
said set of computer readable instructions include instructions for displaying said branded electronic message automatically according to said user information so that the user can preview the electronic message integrated with said at least one wrapper prior to its transmission of said branded electronic message to recipient.

7. The system of claim 6 wherein said computer readable instructions include instructions for canceling transmission of said branded electronic message prior to transmission to the recipient.

8. The system of claim 1 wherein said set of computer readable instructions include instructions for retrieving at least one wrapper from said set of wrappers, receiving modification instructions representing changes to said at least one wrapper, modifying said at least one wrapper according to said modification instructions, and storing said modified wrapper back in said set of wrappers.

9. A system for integrating with an electronic message client for creating customized electronic messages comprising:
a computer readable medium; and,
a set of computer readable instructions embodied in said computer readable medium for functioning in conjunction with said electronic messaging client and receiving an electronic message generated from said electronic messaging client prior to transmission to a recipient, retrieving at least one message wrapper from a set of message wrappers in communication with said computer readable medium, integrating said electronic message with said at least one wrapper for creating a branded electronic message so that a branded electronic message is created for transmission to recipient.

10. The system of claim 9 wherein said set of computer readable instructions include instructions for retrieving user information representing user preferences from said electronic messaging client and retrieving at least one wrapper according to said user information so that said branded electronic message is created according to said user preferences.

11. The system of claim 9 wherein said computer readable instructions include instructions for displaying said branded electronic message so that a user can preview said electronic message integrated with said at least one wrapper prior to transmitting said branded electronic message to the recipient.

12. The system of claim 11 wherein said computer readable instructions include instructions for canceling transmission of said branded electronic message prior to its transmission to the recipient.

13. The system of claim 9 wherein said computer readable instructions include instructions for retrieving at least one wrapper from said set of message wrappers according to user information representing a preferred wrapper of the user.

14. The system of claim 9 wherein said computer readable instructions include instructions for receiving wrapper selection information and retrieving a second message wrapper from said set of wrappers according to said wrapper selection information so that said branded electronic message can be created with said second message wrapper.

15. A method for creating customized electronic messages using an existing electronic message client comprising the steps of:
receiving an electronic message from a user providing at least one message wrapper; and
creating a branded electronic message by integrating said electronic message with at least one said message wrapper prior to initiating transmission of said electronic message to a recipient.

16. The method of claim 15 including the step of providing at least one message wrapper according to wrapper selection information representing the message wrapper preference of the user.

17. The method of claim 15 including the step of canceling transmission of said branded electronic message prior to its transmission to the recipient.

18. The method of claim 15 including the step of displaying said branded electronic message to the user so that the user can preview said branded electronic transmission prior to its transmission.

19. The method of claim 15 including the step of modifying said branded electronic message prior to its transmission to the recipient.

20. The method of claim 15 including the step of transmitting said branded electronic message to the recipient.
